(19) United States
(12) Patent Application Publication
(10) Pub. No.: US 2010/0007208 A1
(43) Pub. Date: Jan. 14, 2010

(54) ELECTRONIC DEVICE AND METHOD FOR SUPPLYING OPERATING VOLTAGE TO FIELD DEVICES

(75) Inventor: Ralf Huck, Grosskrotzenburg (DE)

Correspondence Address: BUCHANAN, INGERSOLL & ROONEY PC, POST OFFICE BOX 1404, ALEXANDRIA, VA, 22313-1404, US

(73) Assignee: ABB TECHNOLOGY AG, Zurich (CH)

(21) Appl. No.: 12/500,301

(22) Filed: Jul. 9, 2009

(30) Foreign Application Priority Data
Jul. 10, 2008 (DE) 10 2008 032 648.8

(51) Int. Cl. H02J 1/00

(52) U.S. Cl. 307/31

(57) ABSTRACT

An electronic device for supplying an operating voltage to field-proximal equipment, in which a bus supplies the operating voltage to the field-proximal equipment via a current loop between a field device and a voltage supply unit which are connected to the bus. The field-proximal equipment includes control means for adaptive operating-voltage matching to an instantaneous power demand. The control means utilizes the energy which is still freely available in the loop.

### RELATED APPLICATION

This application claims priority under 35 U.S.C. § 119 to German Patent No. 10 2008 032 648.8 filed in German on Jul. 10, 2008, the entire content of which is hereby incorporated by reference in its entirety.

### FIELD

The present disclosure relates to an electronic device for supplying an operating voltage to field-proximal equipment, which is supplied via a current loop between a field device and a voltage supply unit which is likewise connected thereto.

Exemplary embodiments of the present disclosure encompass, for example, industrial automation installations for process technology, the automobile industry, the foodstuffs industry, and the like. Industrial installations of interest can include, for example, electronically controllable appliances, such as valves, motors, sensors, which communicate with one another and with at least one superordinate control in analog and/or digital form, via a network.

### BACKGROUND INFORMATION

HART (Highway Addressable Remote Transducer) is one example of a standardized, widely used communication system for the configuration of industrial fieldbuses. HART allows for digital communication via a common data bus between appliances which are integrated therein and are referred to as HART field devices, via the common data bus. In this case, HART makes specific use of the likewise widely used 4-20 mA Standard for transmission of analog sensor signals. The variable range between 4 and 20 mA represents the measured value or manipulated variable of the field device, while the fixed basic current of 4 mA is used for the electrical supply.

Recently, the HART Standardization organization has defined a new HART Standard which refers to wireless signal transmission. The radio transmission that is used in this case is based on the IEEE 802.15.4 wireless communication standard, and uses TDMA (time division multiple access) as the transmission method. This new wireless HART Standard now means that it is possible to integrate HART field devices which communicate in a wireless form into existing systems in a simple manner. If the aim is to integrate HART field devices which communicate in a wireless form into the system as well, then these also need to be supplied with the necessary electrical power via the HART bus, and they need to communicate internally by the use of wires and in a wireless form with further HART field devices or control units which communicate in a wireless form.

DE 10 2006 009 979 A1 discloses an electronic device of this generic type for supplying an operating voltage to HART field devices. The device of this patent document comprises a radio module for conversion of wire-based communication to wireless communication. In order to minimize the power consumption and thereby lengthen the life of an integrated energy store, an energy management unit is provided, by means of which the HART field device can be supplied with the required operating power for predeterminable operating times.

This technical solution has the disadvantage that a current of a different level flows via the 4-20 mA line because of the use of a current loop to supply the operating voltage in a manner dependent on the power consumption of the HART field device, for example, on the measured value produced by the sensor. Because of the long line lengths of more than 100 m within large systems, the voltage drop on the bus line can therefore have a different magnitude. This voltage drop is calculated using Ohm's Law, including the resistance of the bus line and the instantaneous loop current. The operating voltage which is provided by the voltage supply unit is split between the HART field devices, the voltage drop in the bus line, and the voltage of the additionally provided HART field devices which communicate in a wireless form. Often, the supply voltage is merely sufficient for a single additional field device, with a limited line length.

The measure of supplying an operating energy to the HART field device only at predetermined operating times, with the field device then using an energy store to store this operating energy, can result in significant additional technical complexity. Thus, for example, the life of the energy store should be checked at maintenance intervals. The further proposal to use the energy management unit to switch off the operating power for the HART field device which communicates in a wireless form at predeterminable rest times, when no communication is intended, leads to correspondingly restricted availability of the overall system. Furthermore, it is not possible to predict whether operating times with a low power consumption will be available to a sufficient extent to charge the energy store. Continuous operation, independent of the power consumption of the signal transmitter, is accordingly impossible.

Furthermore, a distinction can be drawn between an active signal transmitter, which influences the current in the loop and has a high power consumption (e.g., greater than 40-200 mW depending on the current draw) and a purely passive adaptor with a low power consumption (e.g., less than 10 mW), with the latter being supplied from the current loop as field-proximal equipment. Furthermore, it is assumed that an already installed current loop comprising a feed appliance, line and signal transmitter will always have a sufficiently large margin to allow an adaptor to also be included retrospectively. The margin is at a minimum when high currents are flowing, because of the voltage drop on the line.

### SUMMARY

An exemplary embodiment of the present disclosure provides an electronic device for supplying an operating voltage to a field-proximal equipment. The exemplary electronic device comprises the field-proximal equipment, and a bus configured to supply the operating voltage to the field-proximal equipment via a current loop between a field device and a voltage supply unit connected to the bus. According to an exemplary configuration, the field-proximal equipment comprises control means for adaptive operating-voltage matching to an instantaneous power demand, through utilization of energy which is freely available in the loop.

### BRIEF DESCRIPTION OF THE DRAWINGS

Further advantages and refinements of the present disclosure are explained in more detail below with reference to exemplary embodiments which are illustrated in the attached drawings, in which like reference numerals have been used to denote like elements, and in which:

FIG. 1 shows a schematic illustration of an exemplary bus system with a field device and a field-proximal equipment; and

FIG. 2 shows a block-diagram illustration of an exemplary electronic device for supplying an operating voltage to the field-proximal equipment as shown in FIG. 1.

### DETAILED DESCRIPTION

An exemplary embodiment of the present disclosure provides an electronic device for supplying an operating voltage to the adaptor, which device has the least-possible voltage drop when the loop currents are high.

An exemplary embodiment of the present disclosure provides that a loop-fed equipment has electronic control means for adaptive operating-voltage matching to the instantaneous power demand, where such control means use the energy which is still freely available in the loop.

An advantageous aspect of the exemplary embodiment provided herein is that, for example, the electronic device for supplying an operating voltage and the control means thereof can be attached to an existing bus and in this case, as before, can be supplied with the necessary power therefrom, in addition to the already existing field device. In particular, the generally higher power consumption of field-proximal equipment which communicates in a wireless form can also be encompassed in this way. In this case, the voltage can be a limiting variable, as a result of which the voltage drop is as low as possible. Exemplary embodiments of the present disclosure therefore allow dynamic adaptation of the operating voltage of a device to the loop current which is instantaneously flowing on the bus.

According to an exemplary embodiment, the control means for adaptive operating-voltage matching can, for example, be implemented in those field-proximal equipments which have a constant power consumption. In some circumstances, there may also be a non-linear relationship, because the efficiency of a field device can be dependent on the voltage.

However, it is also feasible to provide adaptive operating-voltage matching to fluctuating operating voltages. These can result, for example, because of corrosion-related changes in the supply line resistances. On the other hand, they can be produced, for example, by fluctuating communication frequencies on the bus. Communication frequencies such as these can be set depending on the speed of the industrial process. High-speed processes result in more frequent communication between the field devices than in the case of slow processes, resulting in a higher power consumption for the wireless communication. The control means according to various exemplary embodiments as provided herein can adjust themselves to such fluctuating conditions.

According to another exemplary embodiment of the present disclosure, the field-proximal equipment can comprise additional measurement means for the determination of electrical parameters of the current loop. In this case, the minimum voltage drop required for the signal transmitter can be determined in particular, and undershooting of a minimum operating voltage of the field deice, for example, can be reliably prevented with the aid of the control means. This means that the maximum possible power is always available for the adaptor without having to interrupt communication and/or analog signal transmission in this case. The actual voltage drop at the signal transmitter can be measured in a suitable manner by the adaptor, for example.

According to an exemplary embodiment, the control means for adaptive operating-voltage matching can comprise a current sensor unit for measurement of the instantaneous loop current on the bus. The level of the current on the 4-20 mA signal line can be, for example, a measure of the instantaneous measured value. The time profile of the current may contain further information, for example a digital bus signal which, when filtered out, is passed on for further processing to a downstream evaluation unit. The instantaneous measured value detected by the measurement means can be used to determine the energy which is still freely available.

According to an exemplary embodiment, further parameters/limit values can be predetermined by the user of the electronic device in order to calculate the energy which is still freely available.

According to an exemplary embodiment, for the purposes of the control means, the current sensor unit can be followed downstream by a filter unit for separation of a useful signal, which is used for operating-voltage matching, in the low-frequency range from the communication signal in the high-frequency range. This optional filtering has no adverse effect on the communication, since there is no voltage adaptation in the frequency ranges that are relevant for communication. It may be possible to dispense with a filter unit such as this if the communication is sufficiently robust such that a disturbance resulting from the voltage adaptation is acceptable.

The current sensor unit or—if present—the downstream filter unit can be, according to an exemplary configuration, followed by a voltage preset unit, which can define the value for the operating voltage U_{B} of the field device on the basis of the instantaneous loop current. A voltage can be defined on the basis of the predetermined operating curve, such as on the basis of the previously filtered signal, which corresponds to the filtered current, for example. This operating curve can result from constraints, such as the maximum power consumption and the minimum operating voltage, and can be correspondingly defined and stored in the voltage preset unit. If necessary, this operating curve may be adapted on the basis of further variables, such as the environmental temperature, component tolerances of the electronic components, safety margins to improve the operating reliability in the system, and the instantaneous power consumption, for example.

Finally, the control means can include a voltage regulation unit, which can follow the voltage preset unit, as an actuating element for setting the operating voltage U_{B} for the field device.

According to an exemplary embodiment, the voltage preset unit can adjust the voltage drop between a positive and negative range, on the basis of a predetermined difference.

The function of the field device in networks with low margins can therefore be advantageously maintained without any disturbances, independent of the presence of optional field-proximal equipment. To this end, optional services which are made available to the field-proximal equipment can be restricted only temporarily.

A further advantage is that existing networks can be retrospectively functionally upgraded by field-proximal equipment without any action on the field devices.

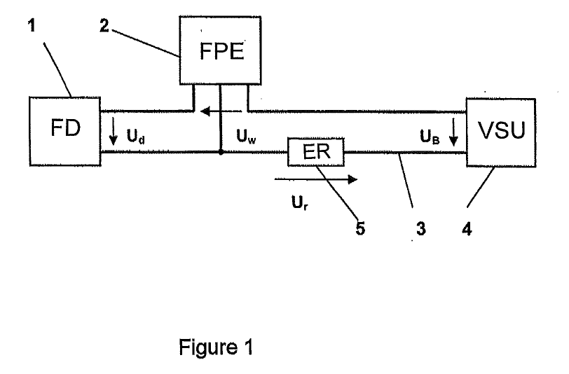

According to FIG. 1, by way of example, a field device (FD) 1 and a field-proximal equipment (FPE) 2 are connected to a voltage supply unit (VSU) 4 via a bus 3 in the form of a current loop. According to an exemplary configuration, the field device 1 can influence the current in the loop. The field device 1 and the field-proximal equipment 2 can be designed to communicate with the bus 3 via the current loop. According to an exemplary embodiment, the current loop can be in the form of a 0/4 . . . 20 mA current loop, in which a current level of 4 mA is reserved for feeding the field device 1, and 0 . . . 16 mA is provided for analog signal transmission.

An equivalent resistance (ER) 5 is inserted into the current loop to illustrate line resistance. According to an exemplary embodiment, the field device 1 can represent a flowmeter in a process installation, and the field-proximal equipment 2 can represent an adaptor, whose data is to be transmitted bidirectionally in wireless form via an integrated radio unit, for example.

According to an alternative exemplary embodiment, the field-proximal equipment 2 can be in the form of an indicator device, which can be configured to visually output the measured value that is determined with the aid of the field device 1.

In another exemplary embodiment, the field-proximal equipment 2 can be in the form of a diagnosis device, which can be configured to monitor the operating capability of the field device 1.

The electrical power which is required for the field device 1 and the field-proximal equipment 2 to carry out their respective operations can be transmitted via the bus 3. This can lead to a voltage drop across the field device I and the field-proximal equipment 2, as well as the voltage supply unit 4. Furthermore, the line length (e.g., resistance) of the bus 3, which is represented by the equivalent resistance 5 in the example of FIG. 1, can reduce the operating voltage.

The operating voltage to be provided by the voltage supply unit 4 is therefore split between the above-mentioned loads. A loop current at a different level can flow on the bus 3, depending on the generally fluctuating power demand of the field device 1 for analog signal transmission.

According to an exemplary embodiment, for adaptive operating-voltage matching to the instantaneous power demand, the field-proximal equipment 2 which communicates in a wireless manner can include control means which reduces the operating voltage U_{W} of the field-proximal equipment 2 when there is a high loop current on the bus 3.

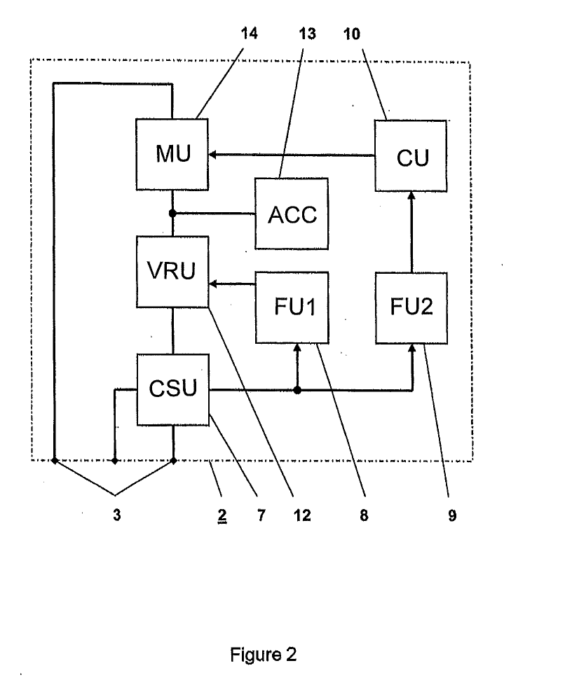

As shown in FIG. 2, the control means can comprise a current sensor unit (CSU) 7 for measurement of the instantaneous loop current on the bus 3. This is followed by a first filter unit (FU1) 8. The first filter unit 8 can be configured to separate a useful signal, which is used for operating-voltage matching, in the low-frequency range from the communication signal in the high-frequency range. The communication signal can be supplied via a second filter unit (FU2) 9 to a control unit 10 for further signal processing. The first filter unit 8 can be followed by a voltage regulation unit 12 to set the operating voltage U_{W} for the field-proximal equipment 2, which can define the value for the operating voltage U_{W} on the basis of the instantaneous loop current.

According to an exemplary embodiment, the control means can include an alternating-current converter (ACC) 13 and a modulator unit (MU) 14, which can be integrated in the bus 3. According to an exemplary embodiment, the modulator unit 14 can be supplied on the input side of the control unit 10 with payload data, for example, and modulate this data onto the bus 3.

According to an exemplary embodiment, the field-proximal equipment 2 can include its own measurement unit, by means of which further measurement variables can be detected. These measurement values can include, in addition to the loop current, for example, the respective voltage drop across the field device 1 as well as process variables which are independent of the field device 1 itself, such as flow, temperature or pressure, which can be recorded by the field device 1.

As the loop current increases, the freely available power in the loop decreases. At a maximum loop current of 20 mA, for example, the freely available power from the loop is minimal, within the scope of the available margin.

Assuming constant power, the operating voltage U_{W} of the connected field-proximal equipment 2 can be regulated on the basis of the measured loop current and the requirements of the components used, as well as the specification, such that this is as low as possible at all times. If the field device communicates in a wireless form, then the operating voltage can be composed of, for example, the minimum input voltage of the alternating-current converter, the power demand for the electronics for producing the useful signal, the efficiency and the amplitude of the modulation signal. Depending on the stated conditions, the stored function makes it possible to automatically reduce the operating voltage U_{W} to thereby achieve minimum input voltage.

If the power preconditions are fluctuated severely, it may be preferable to use the maximum voltage drop which is still available. In this case, the operating voltage can be regulated such that the minimum required operating voltage for the field device 1 is never undershot. When there is a high margin in the loop, more power can be provided. However, the available margin is dependent on the loop current and the line resistance.

The combination of these exemplary techniques and methods for constant and fluctuating power preconditions is particularly advantageous since, in this case, the maximum amount of power which is still available can be used while, at the same time, minimizing the equipment's own consumption.

In each of the above-described exemplary embodiments, it is possible to provide for the field-proximal equipment 2 to be accommodated in the interior of the field device 1. Alternatively, it is possible to provide for the field-proximal equipment 2 to be connected in the current loop spatially independent of the field device 1.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Field device (FD)
2 Field-proximal equipment (FPE)
3 Bus
4 Voltage supply unit (VSU)
5 Equivalent resistance (ER)
7 Current sensor unit (CSU)
8 Filter unit (FU1)
9 Filter unit (FU2)
10 Control unit (CU)
12 Voltage regulation unit (VRU)
13 Alternating-current converter (ACC)
14 Modulator unit (MU)

What is claimed is:

1. An electronic device for supplying an operating voltage to a field-proximal equipment, comprising:
the field-proximal equipment; and
a bus configured to supply the operating voltage to the field-proximal equipment via a current loop between a field device and a voltage supply unit connected to the bus,
wherein the field-proximal equipment comprises control means for adaptive operating-voltage matching to an instantaneous power demand, through utilization of energy which is freely available in the loop.

2. The electronic device as claimed in claim 1,
wherein the field-proximal equipment comprises measurement means for determining electrical parameters of the current loop in the bus.

3. The electronic device as claimed in claim 1,
wherein the control means utilizes the instantaneous measured value detected by the measurement means to determine the energy which is freely available in the loop.

4. The electronic device as claimed in claim 1,
wherein further parameters/limit values can be predetermined by the customer in order to calculate the energy which is still freely available.

5. The electronic device as claimed in claim 2,
wherein the control means utilizes the instantaneous measured value detected by the measurement means to determine the energy which is freely available in the loop.
